(19) United States
(12) Patent Application Publication
(10) Pub. No.: US 2013/0130126 A1
(43) Pub. Date: May 23, 2013

(54) ELECTROCHEMICAL CELL FOR HIGH-VOLTAGE OPERATION AND ELECTRODE COATINGS FOR USE IN THE SAME

(71) Applicant: Giner, Inc., Newton, MA (US)

(72) Inventors: Robert C. McDonald, Stow, MA (US); Katherine E. Harrison, Arlington, MA (US); Castro S.T. Laicer, Watertown, MA (US)

(73) Assignee: GINER, INC., Newton, MA (US)

(21) Appl. No.: 13/650,845

(22) Filed: Oct. 12, 2012

Related U.S. Application Data
(60) Provisional application No. 61/627,422, filed on Oct. 12, 2011.

(51) Int. Cl. H01M 4/583

(52) U.S. Cl. CPC H01M 4/583; Y10S 977/742; Y10S 977/948; B82Y 30/00
USPC 429/338; 429/231.8; 429/223; 429/217; 429/188; 429/199; 429/344; 429/341; 429/340; 429/342; 429/343; 252/506; 977/742; 977/948

(57) ABSTRACT

Electrochemical cell for high-voltage operation and electrode coatings for the same. The electrochemical cell and electrode coatings of the present invention can preferably withstand charging voltages to at least 5-Volts. In one embodiment, the electrochemical cell can include an anode, a cathode, a separator, and an electrolyte, wherein the anode, the cathode, and the separator are operatively associated with the electrolyte. The cathode can include, for example, a mixture of a metal oxide, an elongated carbon structure, and a conductive material. The metal oxide can be, for example, a lithium-nickel-manganese oxide, such as LiNi_{0.5}Mn_{1.5}O₄. The elongated carbon structure can be, for example, a carbon nanotube, a carbon fibril, or a carbon fiber. The conductive material can be, for example, a conductive carbon. The metal oxide, the elongated carbon structure, and the conductive material can be bound together, for example, with a binder.

### CROSS-REFERENCE TO RELATED APPLICATIONS

The present application claims the benefit under 35 U.S.C. 119(e) of U.S. Provisional Patent Application No. 61/627,422, filed Oct. 12, 2011, the disclosure of which is incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract Nos. FA9453-10-M-0129 and NNX09CE22P awarded by the Air Force and NASA, respectively.

### BACKGROUND OF THE INVENTION

The present invention relates to an electrochemical cell that provides for high-voltage operation and to electrode coatings for use in the same.

Lithium-ion cells have become the mainstay of portable devices where good cycle life, low self-discharge, and lower weight are market drivers. Electrochemical cells have been commercialized that utilize different cathode materials and electrolytes, including hydrocarbon carbonates, esters, and ethers as co-solvents. Rechargeable lithium metal anode batteries have also been demonstrated, although their commercialization has been hampered by the reactivity of the electrolytes with lithium dendrites formed at the surface of the anode during charging. Currently used electrolytes also use co-solvents which are flammable (flashpoint less than 60° C.), leading to the risk of fire in the event of cell overheating and venting.

Over the past 40 years, work has been done in studying the conductivity of lithium salts in various aprotic solvents for use in lithium primary (non-rechargeable) and lithium-ion rechargeable cells. Conductivities as high as 20 mS/cm have been measured for aprotic electrolyte use in lithium/thionyl chloride cells (Fey, et. al., 2001). Many of these are flammable with the open-chain ether types somewhat more flammable than the open-chain carbonates. In addition, the high-voltage charging limit of the electrolyte depends on the combination of salt and solvents, as much as the stabilities of either one.

Several lithium salts form solutions in aprotic solvents, including ethylene carbonate (“EC”), which has a high dielectric constant (ε=53). The resulting solvent combinations minimize ion pair formation. Unfortunately, the higher conductivities tend to be derived from solvent systems that include straight-chain esters and ethers. These solvents have very low flash points, which can severely limit the upper temperature for storage and operation of the electrochemical cell. In addition, low-flash-point solvents can contribute to fire hazards associated with vehicle equipment failure and accidents. Liquids with flash points below 60° C. are considered flammable and undesirable for critical applications. The use of cyclic carbonates, such as propylene carbonate (“PC”) and ethylene carbonate (“EC”), improves the situation with higher dielectric constants and flash points, but the low-temperature conductivity for most of the aprotic, organic solvents studied so far severely limits power density. Among the best low-temperature electrolytes investigated have been a 3:1 mix of methyl formate and ethylene carbonate co-solvent with LiAsF₆. The low-temperature (−40° C.) conductivity of this electrolyte was reported as 0.0084 S/cm (Ein-Eli et al., 1997). Unfortunately, the salt is toxic and shows a limited anodic voltage limit.

Many applications requiring high-power pulses delivered from energy storage devices have been met with battery/capacitor hybrid (“BCH”) systems for high specific power and high current flow with short duty cycles. BCH concepts have been the subject of much research in the last decade with the development of ultracapacitors and rechargeable lithium-ion batteries. For example, a hybrid system was fabricated and tested using two 18650 rechargeable lithium cells together with two 100-Farad capacitors (Dougal and Gao, 2006). Using a DC-DC power converter to control current through the battery, capacitor, and load, a peak power level of 135 W was demonstrated and had three times more power than the four devices operating in a passive mode, as well as a seven-fold higher power than the lithium batteries alone (Dougal and Gao, 2006). The power conditioner has the advantage of pairing two types of rechargeable power sources with dissimilar rate capability and internal resistance. The disadvantage of this approach is that the power conditioning electronics add weight and volume to the system and waste energy which is dissipated as heat, often adding to the problem of thermal management. The concept also adds additional elements to the circuit, possibly jeopardizing system reliability over many years.

Pseudocapacitors with aqueous electrolytes and electrodes consisting of metal oxides having high specific capacitance, but a limited cell voltage of 1.0 V for RuO₂ electrodes in water (Jow and Zheng, 1998) and with organic alkyl carbonate electrolytes limited to 3.2 V (Zheng, 2009). Redox-type capacitors using symmetrical electrodes with lithium intercalated metal oxides and non-aqueous lithium-ion electrolytes can be used to store and deliver power at voltages up to 5 V for short duty cycles with high specific capacitance. However, diffusion effects in the solid phase limit the total current delivered to ˜2 mA/cm², which is on the same order as lithium-ion batteries.

With a high-voltage stable electrolyte combined with a high-voltage stable cathode that include ultra-high-surface-area carbon, a lithium (or lithium-ion) anode and cathode will charge while a double-layer forms on the carbon facilitating a large increased in stored energy. Certain non-flammable electrolytes (McDonald, 2008) combined with a lithium-manganese nickel oxide cathode can withstand charge voltages of 5.0 V, and discharge voltages in excess of 4.8V (McDonald and O'Toole, 2009). When the intercalation anode carbon and the cathode capacities are reached at ˜5.0 V, the high-surface-area carbon continues to form a double layer. This is evidenced by the discharge capacity of cells in pulse string mode, which provides more ampere-hour capacity than would be expected for the cathode oxide itself. For low rate power, the lithium-ion materials support the current to deliver useful capacity. With a high-current, low-impedance load, the double layer will first discharge at a rate limited only by the electrolyte conductivity and electrode impedance.

The following patent documents, all of which are incorporated herein by reference, may be of interest: U.S. Patent Application Publication No. US 2008/0193855 A1, inventor Robert C. McDonald, published Aug. 14, 2008; U.S. Pat. No. 6,515,845 B1, inventors Oh et al., issued Feb. 4, 2003; and U.S. Pat. No. 6,019,803, inventors Oskam et al., issued Feb. 1, 2000.

In addition, the following non-patent documents, all of which are incorporated herein by reference, may be of interest: Dougal, R. A., S. Liu, R. E. White, Power and Life Extension of Battery-Capacitor Hybrids, In IEEE Transactions on Components and Packaging Technologies, Vol. 25, No. 1, 120-131 (2002); Dougal, R. A. and L. Gao, Soldier System Power Sources, Final Report for ONR Contract No. N00014-03-1-0932, Aug. 15, 2006; Fey, G. T-K., W-K Liu and Y-C Chang, “Temperature and concentration effects on the conductivity of LiAlCl4/SOCl2 electrolyte solutions”, J. Power Sources, 97, 602 (2001); Guerts, F. W. A. H. and R. C. McDonald, 37^{th} Power Sources Conference, Cherry Hill, N.J., 1995; Jow, T. R.. and J. P. Zheng, J. Electrochem. Soc., 145, 49 (1998); Kuo, S.-L. and N. L. Wu, J. Electrochem. Soc., 10, A171 (2007); Lu, W, K. Henry, C. Turchi, J. Pellegrino, J. Electrochem. Soc., 155, A161 (2008); McDonald, R. C., “Lithium Battery Electrolytes for Long Cycle Life and Wide Operating Temperature Range,” NASA Glen Research Center, Final Report, Contract NNCO4CA58C, July 2004; McDonald, R. C., S O'Toole, “Non-Flammable, High Voltage Electrolytes for Lithium Ion Batteries,” Final Report, National Aeronautics and Space Administration Contract NNX09CE22P, July 2009; McDonald, R. C. and C. S. T. Laicer, “Integrated High Voltage Lithium Ion Battery—Ultracapacitor Hybrid,” Final Report, US AFRL Contract FA9453-10-M-0129, March 2011; McDonald, R. C., K. E. Harrison, C. S. T. Laicer, “Hybrid Battery/Capacitor Power for Increased Power and Energy Density and Safety”, Final Report, US Naval Air Warfare Center Contract No. N68335-11-C-0179, June 2011; Rajan, M., “Global Market for Premium Portable Power Sources to Reach $6.3 Billion by 2009,” Press Release, Business Communication Co, Inc., Nov. 10, 2004; Saxman, D., FCB028D Lithium Batteries: Markets and Materials, Business Communications Company, Inc., July, 2007; Shiraishi, S., Y. Aoyama, H. Kurihara, A. Oya, T. Liang, Y. Yamada, Electric Double Layer Capacitance of porous carbon derived from PTFE with Lithium Metal, American Carbon Society Annual Proceedings, Jul. 14-19, 2001, Lexington, Ky.; Zheng, J. P., J. Electrochem. Soc., 156, A500 (2009); and Zhong, Q, A. Bonakdarpour, M. Zhang, Y. Gao and J. R. Dahn, J. Electrochem. Soc., B144, 205 (1997).

### SUMMARY OF THE INVENTION

It is an object of the present invention to provide a novel conductive coating. The novel conductive coating of the present invention may comprise a first material, a second material, and a third material, the first material being a metal oxide, the second material being an elongated carbon structure, and the third material being a conductive material. The metal oxide of the conductive coating may comprise a lithium-nickel-manganese oxide. The elongated carbon structure of the conductive coating may comprise at least one of a carbon nanotube, a carbon fibril, and a carbon fiber. The conductive material of the conductive coating may comprise a conductive carbon. The conductive coating may further comprise a fourth material, the fourth material being a binder. The binder may be selected from the group consisting of polyvinylidine difluoride and polyvinylidine difluoride-hexafluoropolypropylene block copolymer. Preferably, the thickness of the conductive coating is 3 mm or less.

It is yet another object of the present invention to provide a novel cathode or cathode coating for use in an electrochemical cell. The novel cathode or cathode coating of the present invention may comprise a first material, a second material, and a third material, the first material being a metal oxide, the second material being an elongated carbon structure, and the third material being a conductive material. The aforementioned metal oxide may comprise a lithium-nickel-manganese oxide. The aforementioned elongated carbon structure may comprise at least one of a carbon nanotube, a carbon fibril, and a carbon fiber. The aforementioned conductive material may comprise a conductive carbon. The cathode or cathode coating may further comprise a fourth material, the fourth material being a binder. The binder may be selected from the group consisting of polyvinylidine difluoride and polyvinylidine difluoride-hexafluoropolypropylene block copolymer. Preferably, the thickness of the cathode or cathode coating is 3 mm or less.

It is still yet another object of the present invention to provide a novel anode or anode coating for use in an electrochemical cell. The novel anode or anode coating of the present invention may comprise a material selected from the group consisting of an intercalated carbon, a conductive carbon, and an elongated carbon structure. The aforementioned elongated carbon structure may comprise at least one of a carbon nanotube, a carbon fibril, and a carbon fiber. Preferably, the thickness of the anode or anode coating is 3 mm or less.

It is a further object of the present invention to provide a novel electrochemical cell that comprises an anode, a cathode, a separator, and an electrolyte, wherein the anode, the cathode, and the separator are operatively associated with the electrolyte and wherein the cathode may comprise a mixture of a first material, a second material, and a third material, the first material being a metal oxide, the second material being an elongated carbon structure, and the third material being a conductive material.

The aforementioned metal oxide may comprise a lithium-nickel-manganese oxide. The aforementioned elongated carbon structure may comprise at least one of a carbon nanotube, a carbon fibril, and a carbon fiber. The aforementioned conductive material may comprise a conductive carbon. The cathode may further comprise a binder. The binder may be selected from the group consisting of polyvinylidine difluoride and polyvinylidine difluoride-hexafluoropolypropylene block copolymer. Preferably, the thickness of the cathode is 3 mm or less.

The aforementioned anode may comprise lithium metal. Alternatively, the aforementioned anode may comprise a material selected from the group consisting of an intercalated carbon, a conductive carbon, and an elongated carbon structure. The elongated carbon structure may be at least one of a carbon nanotube, a carbon fibril, and a carbon fiber. The anode may further comprise a binder. The binder may be selected from the group consisting of polyvinylidine difluoride and polyvinylidine difluoride-hexafluoropolypropylene block copolymer. Preferably, the thickness of the anode is 3 mm or less.

The aforementioned electrolyte may comprise at least one fluorinated solvent. The fluorinated solvent may include at least one of a fluorinated ester, a fluorinated alkyl dione, a fluorinated hydrocarbon, or a fluorinated sulfolane. The electrolyte may further comprise a lithium salt. The lithium salt may comprise one or more of lithium hexafluoro phosphate (LiPF₆), lithium tetrafluoroborate (LiBF₄), lithium hexafluoroarensate (LiAsF₆), lithium perchlorate (LiClO₄), lithium bis(oxalate)borate (LiBOB), lithium bis-(trifluoromethanesulfonyl) imide, and lithium trifluoromethane sulfonate (LiCF₃SO₃). The electrolyte may further comprise a carbonate solvent, which may be an alkyl carbonate.

The aforementioned fluorinated ester may comprise one or more fluorinated esters selected from the group consisting of 2,2,2-trifluoroethyl acetate, 2,2,2-trifluoroethyl butyrate, ethyltrifluoro acetate, methyl pentafluoropropionate, and 2,2,2-trifluoroethyl propionate. Alternatively, the fluorinated ester may comprise a fluorinated ester solvent having a dipole moment greater than 4.0. As yet another alternative, the fluorinated ester may be of the general formula CH₃—(CH)ₙ—CO₂—(CH)ₘ—CF₃, where n and m are independent integer numbers from 1 to 5.

The aforementioned fluorinated alkyl dione may be selected from the group consisting of 1,1,1 -trifluoro-2,4-pentanedione and 1,1,1,5,5,5-hexafluoropentane-2,4-dione. Alternatively, the fluorinated alkyl dione may be of the general formula CF₃(CH₂)ₙ—(CO)—(CH₂)ₘ—(CO)—(CH₂)ₚCX₃, where n=0, 1, 2, 3, 4, m=1, 2, 3, p=0, 1, 2, 3, 4, and X═H or F.

The aforementioned fluorinated sulfolane may comprise one or more fluorinated sulfolanes selected from the group consisting of 3-monofluorosulfolant and 2,3-difluorosulfolane.

The aforementioned fluorinated hydrocarbon may be selected from the group consisting of 2,3-dihydrodecafluoropentane and the azeotropic mixture of CF₃CF₂CHCCl₂/CClF₂CF₂CHClF.

The aforementioned alkyl carbonate may be selected from the group consisting of propylene carbonate, butylene carbonate, ethylene carbonate, ethyl methyl carbonate, dimethyl carbonate, and the partially-fluorinated derivatives of these named alkyl carbonate species.

It is still a further object of the present invention to provide a novel electrochemical cell that comprises an anode, a cathode, a separator, and an electrolyte, wherein the anode, the cathode, and the separator are operatively associated with the electrolyte and wherein the cathode comprises a mixture of a first material and a second material, the first material being a metal oxide, the second material being an elongated carbon structure, the elongated carbon structure being electrically conductive.

The aforementioned cathode may further comprise a third material, the third material being a conductive carbon.

The aforementioned cathode may further comprise a fourth material, the fourth material being a binder.

The aforementioned metal oxide of the cathode may be electrically non-conductive and may comprise, for example, a lithium-nickel-manganese oxide, such as LiNi_{0.5}Mn_{1.5}O₄.

The aforementioned elongated carbon structure of the cathode may comprise at least one member of the group consisting of a carbon nanotube, a carbon fibril, and a carbon fiber. The aforementioned carbon fiber may be an activated carbon fiber.

Additional objects, as well as aspects, features and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF DRAWINGS

The accompanying drawings, which are hereby incorporated into and constitute a part of this specification, illustrate various embodiments of the invention and, together with the description, serve to explain the principles of the invention. In the drawings wherein like reference numerals represent like parts:

FIG. 1 is one embodiment of an electrochemical cell according to the teachings of the present invention;

FIG. 2 is a SEM photo of one embodiment of the cathode coating according to the teachings of the present invention;

FIG. 3 is a table of electrolyte formulations that may be used in electrochemical cell according to the teachings of the present invention;

FIG. 4 is a graph of the X-ray powder diffraction pattern for high voltage spinel cathode material LiNi_{0.5}Mn_{1.5}O₄₋;

FIG. 5 is a Linear Sweep Voltammetry (LSV) graph of electrolytes according to the teachings of the present invention and comparative commercial electrolytes;

FIG. 6 is a graph of the pulse discharge of a lithium-ion cell with a carbon anode and a cathode containing a disordered spinel and super P carbon;

FIG. 7 is a graph of the cycle performance of Li/LiNi_{0.5}Mn_{1.5}O₄ cell (at 20° C. and −14° C.) with electrolyte G (see FIG. 3 for composition of electrolyte G) at C/2 rate;

FIG. 8 is a graph of the cycle performance of Li/LiNi_{0.5}Mn_{1.5}O₄ cell with electrolyte G at C/20 rate with short low temperature cycling (−75° C.) before returning to room temperature cycling;

FIG. 9 is a graph of the pulse discharge of a lithium cell comprising ACF fibers, spinel, and electrolyte F;

FIG. 10 is a graph of the pulse discharge of a lithium cell comprising MWCNT, spinel, and electrolyte F;

FIG. 11 is a graph of the cell discharge for an electrochemical cell comprising a lithium anode, a MWCNT/spinel cathode, and Electrolyte E;

FIG. 12 is a graph of the power density (W/kg) versus % duty cycle for hybrid cathodes containing ACF/Super-P compared with conventional battery cathodes containing Super-P;

FIG. 13 is a graph of the energy density (Wh/kg) versus % duty cycle for hybrid cathodes containing ACF/Super-P compared with conventional battery cathodes containing Super-P;

FIG. 14 is a graph of the power density (Wh/kg) versus % duty cycle for hybrid cathodes containing ACF/Super-P and hybrid cathodes containing MWCNT's compared with conventional battery cathodes containing Super-P;

FIG. 15 is a graph of the energy density (Wh/kg) versus % duty cycle for hybrid cathodes containing ACF/Super-P and hybrid cathodes containing MWCNT's compared with conventional battery cathodes containing Super-P;

FIG. 16 is a graph of the charge (10C rate to 5V) and discharge (2C rate to 3V) of a lithium cell with SLP-50 graphite anode, spinel cathode, and electrolyte I;

FIG. 17 is a graph of the cell pulse discharge profile at 2.2 Amps/g of spinel; and

FIG. 18 is a graph of the cell pulse discharge profile at 10.4 Amps/g of spinel.

### DETAILED DESCRIPTION OF THE INVENTION

Currently available high-voltage electrochemical cell technology is hampered by the limitations of operating temperature, health hazards, and electrolyte flammability. In part to overcome these limitations, the present invention incorporates elongated carbon structures in at least one of the anode and cathode coatings. Elongated carbon structures include, but are not limited to, carbon fibers, carbon nanotubes, and carbon fibrils.

The elongated carbon structures added to the anode and cathode structures have the ability to tolerate charge voltages of 5.0 V (McDonald and O'Toole, 2009). In a lithium-ion cell, for example, when the intercalation anode carbon and the cathode capacities are reached at ˜5.0 V, the high-surface-area elongated carbon structures continue to form a double layer. For low rate power, the lithium-ion cell can support the current to deliver useful capacity. With a high-current, low-impedance load, the double layer will discharge first at a rate limited only by the electrolyte conductivity and electrode impedance.

For example, activated carbon fibers (“ACF”)—a type of elongated carbon structure as defined above—can provide the necessary specific capacity. ACF can provide as much as 250 F/g in aqueous KOH electrolytes with discharge currents of 200 to 4000 mA/g (Guerts and McDonald, 1995). The capacity stored as double-layer capacitance is available for discharge into the load at very high currents compared to commercially-available battery-active materials. The present invention provides this phenomenon because the discharge of ions off the carbon surface are not limited by solid state diffusion, activation overpotentials, or concentration gradients, as is the case for the commercially-available batteries. By careful adjustment of heat treatment cycles, the pore size of high-surface-area carbons can be optimized for the electrolyte salt used in the electrochemical cell, such LiPF₆ (Kim et al., 2004).

To further overcome the limitations of current high-voltage electrochemical cell technology, the cathode and/or anode containing elongated carbon structures were combined with electrolytes containing fluorinated solvents, a fluorinated ester, fluorinated alkyl dione, a fluorinated hydrocarbon, or a fluorinated sulfolane. The fluorinated solvents contained in these electrolytes were selected based on high dipole moments, low melting points, and low viscosity, thus resulting in decreased flammability and increased safety in the event of external fire or overheating. The electrolytes may further include an alkyl carbonate. When said electrolytes are combined with cathodes and/or anodes containing the elongated carbon structures, the resulting novel electrochemical cell in the present invention allows for cycling with higher charging voltages than present currently-available electrochemical cells. As a result of, the electrochemical cell of the present invention allows for higher operating voltages, energy density, and power density.

In the claimed invention, cathodes for lithium and lithium-ion cells are prepared as a coating of less than 3 mm in thickness on a suitable metal substrate. For example, the first step in preparing cathode coating is to prepare the spinel metal oxide powder. To prepare the spinel metal oxide powder, MnO₂, NiCO₃, and Li₂CO₃ in a Li/Ni/Mn are mixed in a molar ratio of 1/0.5/1.5. These powers are then thoroughly mixed and ground in a high-speed ball mill for 18 hours. The mixture is pressed into pellets and heated in a tube furnace to 900° C. over three hours. The mixture is held at 900° C. for 12 hours under flowing dry air. The mixture is then allowed to cool to room temperature over 8-12 hours. The resulting metal oxide powder is then ground in a mortar and pestle for the next step in the cathode coating preparation.

The second step in preparing the cathode coating is to make a powder blend containing 90% of the spinel metal oxide powder prepared above, 5% polyvinylidene difluoride binder powder, 2.5% multiwalled carbon nanotubes, and 2.5% conductive carbon. This mixture is made into a slurry by thoroughly mixing with N-methyl pyrrolidone liquid. The slurry is poured onto a precut sheet of aluminum foil and slowly bar-coated to produce a thin layer of uniform thickness. The coated foil is than heated to 80° C. under vacuum to drive off the liquid. The dry coating is than cured at 120 oC to bond the components together, and to bond the coating to the foil.

An example of an anode for a lithium-ion cells is prepared by mixing a blend of 90% graphitic carbon powder carbon, 5% polyvinylidene difluoride, 2.25% multi-walled carbon nanotubes, and 2.25% conductive carbon This mixture is made into a slurry by thoroughly mixing with N-methyl pyrrolidone liquid. The slurry is poured onto a precut sheet of copper foil and slowly bar-coated to produce a thin layer of uniform thickness. The coated foil is than heated to 80° C. under vacuum to drive off the liquid. The dry coating is than cured at 120 oC to bond the components together, and to bond the coating to the foil.

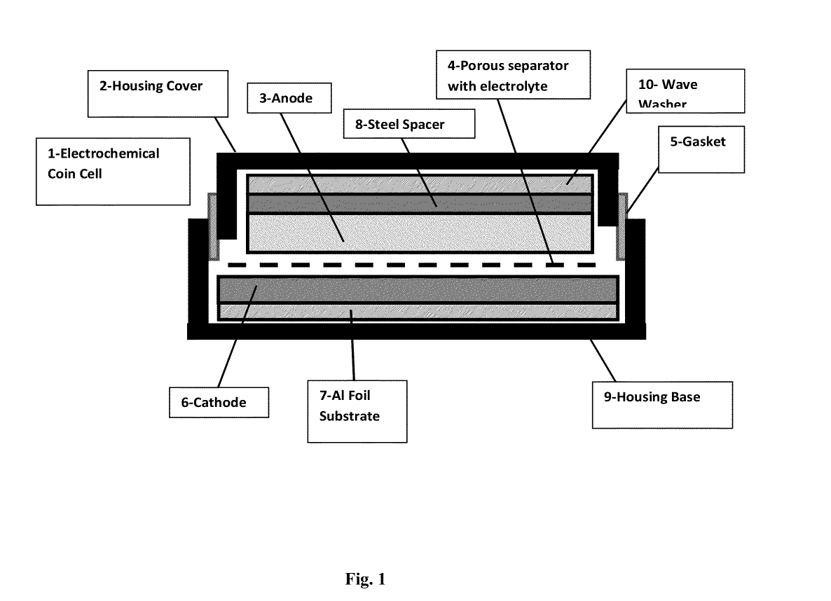

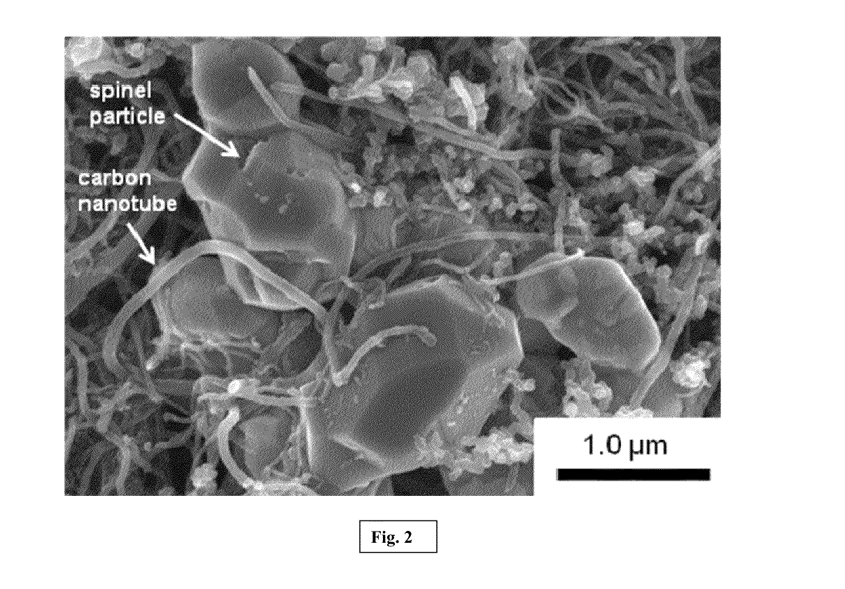

Referring to FIG. 1, an electrochemical coin cell 1 is fabricated by first coating A1 (aluminum) foil substrate 7 with cathode 6, whereby cathode 6 material is prepared according to the procedure described above and cut out into a disk. Next, porous separator 4 (e.g., a disk of microporous polyolefin membrane) is placed over cathode 6. Electrolyte is added to the porous separator 4 area between anode 3 and cathode 6 to ensure ionic continuity between anode 3 and cathode 6. Anode 3, prepared according to the procedure described above and cut out into a disk, is then placed on top of porous separator 4. Steel spacer 8 and wave washer 10 are placed on top of anode 3. Gasket 5 is then inserted into the case and the assembly is pressed together with a precision crimper, thus completing the fabrication of cell 1.

The electrolyte solvents used in cell 1 (as discussed in the examples below) were selected based on high dipole moments, low melting points, low viscosity, and favorable miscibility with cyclic carbonates for lithium salt dissociation, such as 1,1,1-Trifluoro-2,4-pentanedione (TFP), 2,2,2-Trifluoroethyl acetate (TFEA), and 1,1,1,5,5,5-hexafluoropentane-2,4-dione (HFP). In addition, two fluorinated straight-chain hydrocarbons (Azeotrope of 3,3-Dichloro-1,1,1,2,2-pentafluoropropane/1,3-Chloro, 1-Hydropentafluoropropane [CF₃CF₂CHCl₂/CClF₂CF₂CHClF], and 2,3-Dihydrodecafluoropentane [CF₃CHFCHFCF₂CF₃]) were found to be especially effective at enhancing high-voltage stability and low-temperature performance when used as co-solvents with the above-mentioned fluorinated solvents. The solvents are commercially available at low cost, are stable in contact with lithium, have low viscosity, and no flashpoint.

The following examples are provided for illustrative purposes only and are in no way intended to limit the scope of the present invention:

### Example 1

### Preparation and Properties of Electrolyte C

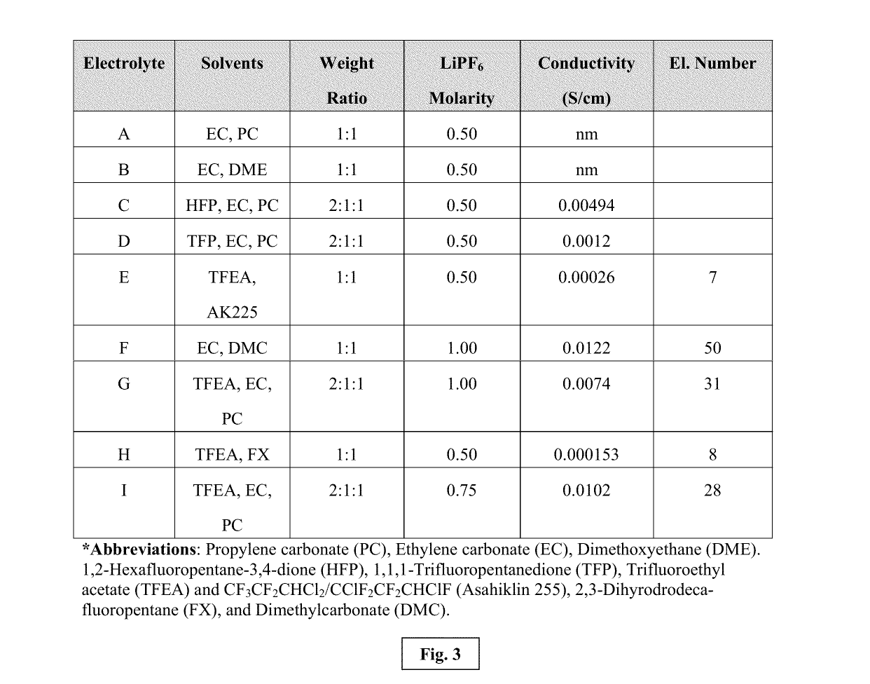

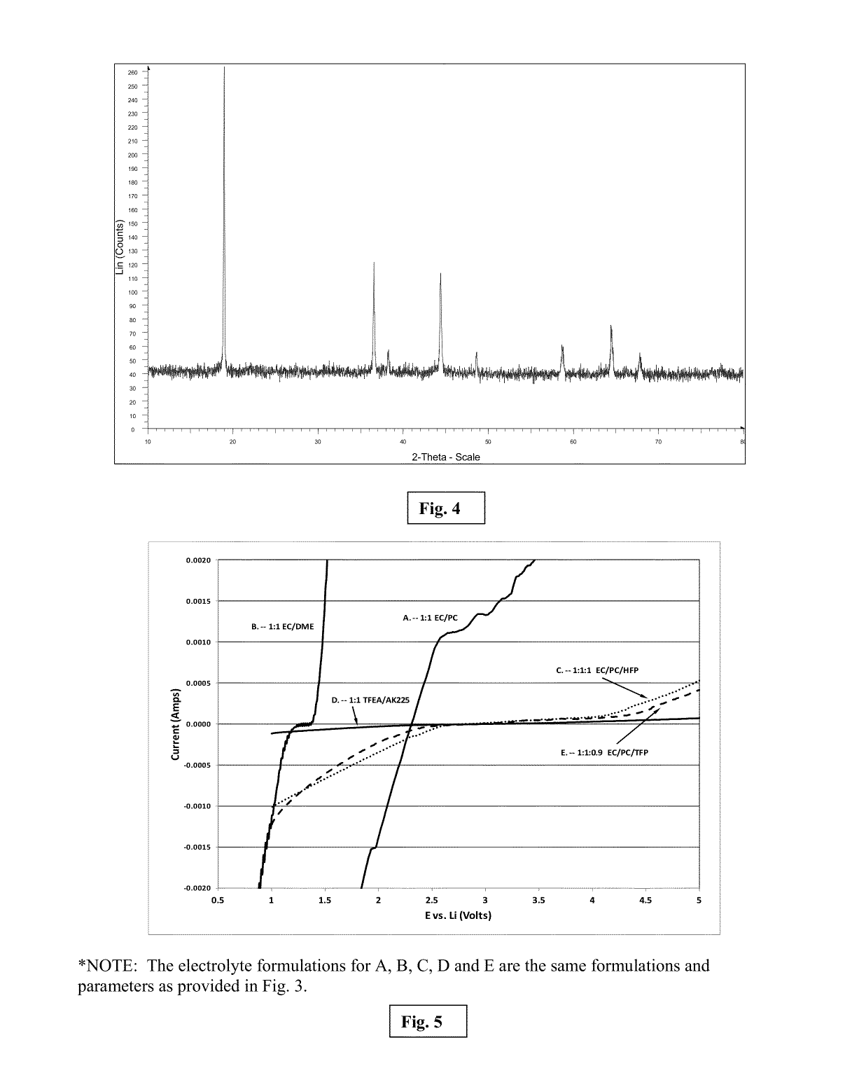

An electrolyte was prepared by dissolving 1.58 g LiPF₆ in 6 mL of HFP together with 14 mL of a 1:1 by weight mixture of propylene carbonate and ethylene carbonate. The resulting solution contained 0.5M LiPF₆ with a freezing point below −70° C. and a conductivity of 0.00494 S/cm at 20° C. (see FIG. 3 for more details on the composition and properties of electrolyte C)

### Example 2

### Preparation and Properties of Electrolyte D

An electrolyte was prepared by dissolving 2.28 g LiPF₆ in 6 mL of TFP together with 14 mL of a 1:1 by weight mixture of propylene carbonate and ethylene carbonate. The resulting solution contained 0.75M LiPF₆ with a freezing point below −70° C. and a conductivity of 0.00658 S/cm at 20° C. (see FIG. 3 for more details on the composition and properties of electrolyte D)

### Example 3

### Preparation and Properties of Electrolyte E, F, and G

Electrolytes were prepared by dissolving 1.58 g, 2.37 g and 3.16 g LiPF₆, respectively, in 10 mL of TFEA together with 10 mL of an azeotropic mixture of CF₃CF₂CHCCl₂/CClF₂CF₂CHClF to give solution of 0.5M, 0.75M, and 1.0M LiPF₆. These mixtures comprise electrolytes E, F, and G, respectively (see FIG. 3 for more details on the composition and properties of electrolyte E, F, and G).

### Example 4

### Preparation and Properties of Electrolyte H

An electrolyte was prepared by dissolving 1.58 g LiPF₆ in 10 mL of TFEA together with 10 mL of solvent Vertrel FX from Dupont, Inc. Vertrel FX is the partially fluorinated solvent 2,3-Dihyrodrodecafluoropentane. The resulting solution contained 0.50M LiPF₆ with a freezing point below −70° C. and a conductivity of 0.00023 S/cm at 20° C. (see FIG. 3 for more details on the composition and properties of electrolyte H).

### Example 5

### Preparation and Properties of Electrolyte I

An electrolyte was prepared by first mixing 10 mL of dry 1,1,1-Trifluoroethylacetate (TFEA) together with 10 mL of a cosolvent blend consisting of a 1:1 weight mixture of propylene carbonate and ethylene carbonate. 2.28 grams of LiPF₆ of LiPF₆ added to give a 0.75M solution. The solution had freezing points below −70° C. and conductivities of 0.0102 S/cm at 20° C. and 0.00156 S/cm at −40° C. (see FIG. 3 for more details on the composition and properties of electrolyte I).

### Example 6

### Method of Preparing Cathode Spinel Material

A metal oxide with a spinel crystal structure having the formula LiNi_{0.5}Mn_{1.5}O₄was prepared by mixing MnO₂, NiCO₃, and Li₂CO₃ in a Li/Ni/Mn molar ratio of 1/0.5/1.5. The powers were thoroughly mixed and ground in a high-speed ball mill for 18 hours. The mixture was pressed into pellets and heated in a tube furnace to 900° C. over a 3-hour period. The material was held at 900° C. for 12 hours under flowing dry air. The material was then allowed to cool to room temperature over 8-12 hours. The material was ground in a mortar and pestle before assembling into cathode electrodes. An x-ray powder diffraction pattern was recorded as shown in FIG. 4.

### Example 7

### Demonstration of Cell Performance with Commercial Electrolytes Versus the Electrolytes Described in the Present Invention

Commercial type lithium ion electrolytes were prepared as controls to evaluate the electrochemical stability of the electrolytes described in Examples 1-3. The control electrolytes consisted of electrolyte A (0.5M LiPF₆ in a 50:50 mixture of ethylene carbonate and propylene carbonate) and electrolyte B (0.5M LiPF₆ in a 50:50 mixture of ethylene carbonate and dimethoxyethane). Electrolytes were placed in a 3-electrode cell having a lithium counter electrode, a graphite working electrode, and a lithium reference electrode. The working electrode was electrochemically scanned using linear sweep voltammetry at 10 mV/sec sweep rated from 0.1 V to 6 V vs. the lithium reference electrode. Cell current was recorded for each of the two control electrolytes (see further details of electrolytes A and B in FIG. 3) and the electrolytes disclosed in this invention (see further details of electrolytes C, D, and E in FIG. 3). The resulting curves are shown in FIG. 5.

### Example 8

### Demonstration of 5-Volt Cell Performance Discharged with 5-Second Pulses According to the Teachings of the Present Invention

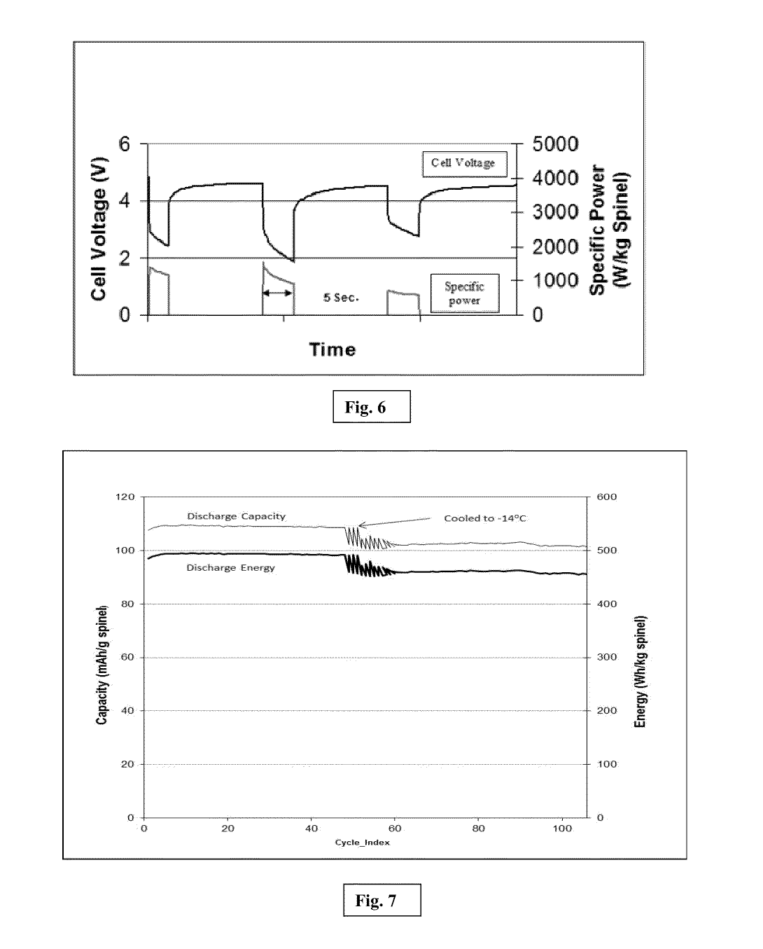

A CR2032 size coin cell was constructed using a synthetic graphite MPG-113 (Mitsubishi), a cathode with 80 wt % LiNi_{0.5}Mn_{1.5}O₄(prepared in Example 6), 5 wt % Teflon® binder, 15 wt % Super P carbon (Timcal), and electrolyte G (see further details of electrolytes G in FIG. 3). The cell was charged at constant current to 5 volts to yield a stable open circuit voltage of 4.87 V. The cell was pulse-discharged twice for 5 seconds (at C/5 rate) at 0.48 A/g spinel followed by one pulse at 0.24 A/g spinel. The cell polarized to 1.87 to 2.77 V providing 700-1520 W/kg of spinel. The cell voltage rapidly returned to an open circuit voltage of 4.64 V (see FIG. 6).

### Example 9

### Demonstration of 5-Volt Cell Performance According to the Teachings of the Present Invention

A coin cell was constructed using the LiNi_{0.5}Mn_{1.5}O₄ cathode as in Example 8, a lithium anode, and electrolyte G (see further details of electrolytes G in FIG. 3). The cell was cycled at the C/2 rate between 5.0 V and 3.0 V to yield over 400 Wh/kg of cathode material and cell discharge voltage above 4.2 V (see FIG. 7).

### Example 10

### Demonstration of 4.8-Volt Cell Performance According to the Teachings of the Present Invention

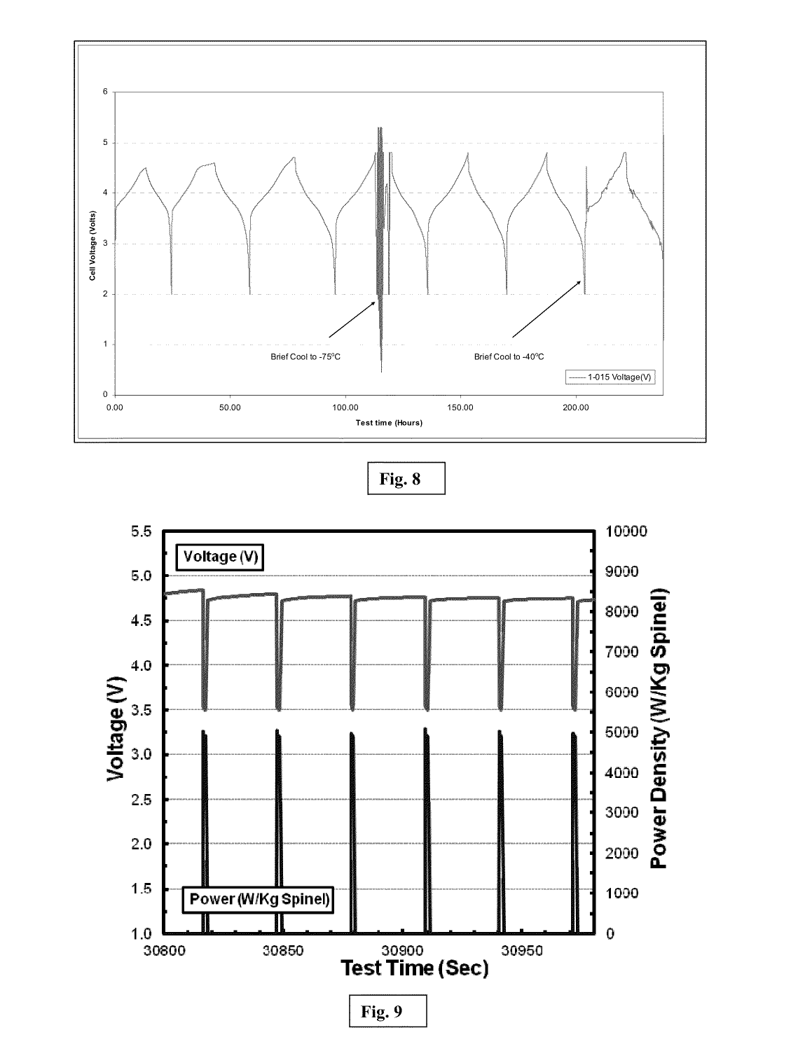

A coin cell was constructed using the a Li_{1.17}Mn_{0.58}Ni_{0.25}O₂ cathode, a lithium anode, and electrolyte G F (see FIG. 3 for further details of electrolyte G). The cell was cycled over 130 times between 4.8 and 2.0 volts at C/20 rate to yield over 400 Wh/kg of cathode material with an average discharge voltage of 3.7 V (see FIG. 8).

### Example 11

### Demonstration of Li/LiNi_{0.5}Mn_{1.5}O₄ (with ACF) Cell Performance According to the Teachings of the Present Invention

A coin cell was constructed using a cathode with 85 wt % LiNi_{0.5}Mn_{1.5}O₄material (prepared according to the procedure in Example 6), 5 wt % PVdF binder, 5 wt % Super P carbon (Timcal), 5 Wt % Activated Carbon Fibers (ACF from Kynol), and electrolyte F (see FIG. 3 for further details of electrolyte F). The cell was charged at constant current to 5 volts to yield a stable open-circuit voltage of 4.87 V. The cell was discharged with one-second pulses at 0.24 A/g LiNi_{0.5}Mn_{1.5}O₄. The cell polarized to 2.9 V providing 4300 W/kg of LiNi_{0.5}Mn_{1.5}O₄. The cell voltage rapidly returned to an open-circuit voltage of 4.64 V between pulses (see FIG. 9).

### Example 12

### Demonstration of Li/LiNi_{0.5}Mn_{1.5}O₄ (with MWCNT) Cell Performance According to the Teachings of the Present Invention

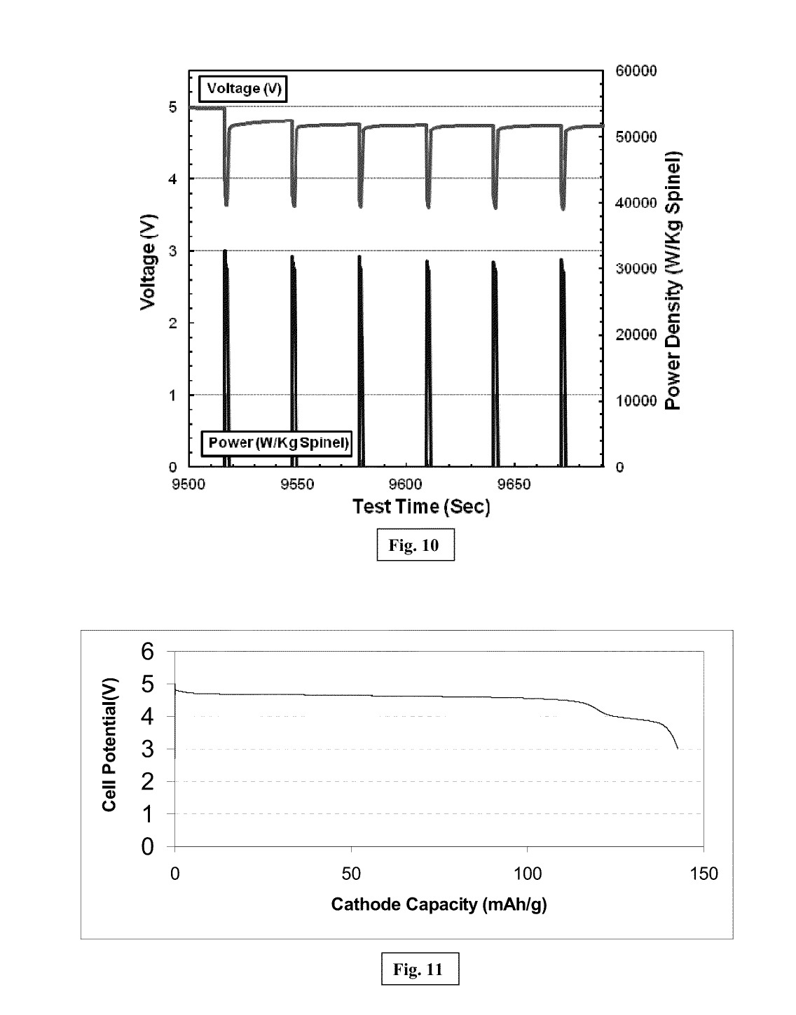

A coin cell was constructed using a cathode with 85 wt % LiNi_{0.5}Mn_{1.5}O₄ material (prepared in Example 6), 5 wt % PVdF binder, 5 wt % Super P carbon (Timcal), 5 wt % multiwalled carbon nanotubes (MWCNT from U.S. Research Nanomaterials, Inc.), and Electrolyte F (see FIG. 3 for further details of electrolyte F). The cell was charged at constant current to 5 volts to yield a stable open-circuit voltage of 4.89 V. The cell was discharged with one-second pulses at 0.24 A/g LiNi_{0.5}Mn_{1.5}O₄. The cell polarized to 3.5 V providing 5000 W/kg of LiNi_{0.5}Mn_{1.5}O₄. The cell voltage rapidly returned to an open-circuit voltage of 4.64 V between pulses (see FIG. 10).

### Example 13

### Demonstration of Li/LiNi_{0.5}Mn_{1.5}O₄ (with MWCNT) Cell Performance with Electrolyte E According to the Teachings of the Present Invention

A coin cell was constructed using a lithium anode and a cathode consisting of 90 wt % LiNi_{0.5}Mn_{1.5}O₄ material 5 wt % Teflon® binder, 8.5 wt % Super P carbon, and 8.5% MWCNT with Electrolyte E (see FIG. 3 for further details of electrolyte E). The cell was charged at 46 mA/g spinel to 5 volts to yield a stable open-circuit voltage of 4.85 V. The cell was then discharged at 92 mA/g spinel to a 3.0 V cutoff. The cell operated at an average voltage of 4.63 V and gave a cathode utilization of 143 mAh/g (FIG. 11).

### Example 14

### Comparison of Li/LiNi_{0.5}Mn_{1.5}O₄ Cell Performance with Li/LiNi_{0.5}Mn_{1.5}O₄ with ACF) Cell Performance

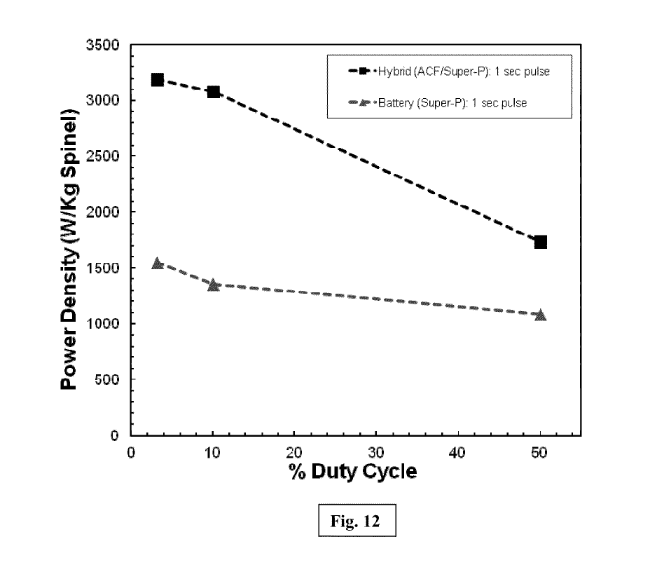

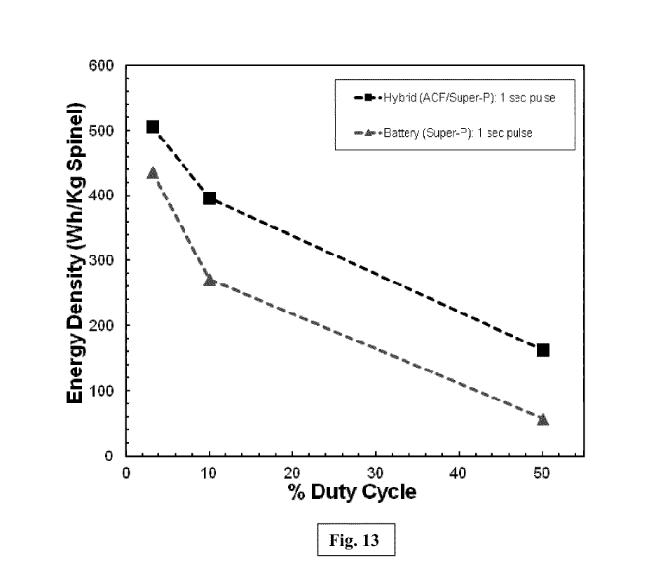

A coin cell battery was constructed using a lithium anode and a cathode consisting of 90 wt % LiNi_{0.5}Mn_{1.5}O₄ material 5 wt % Teflon® binder, 8.5 wt % Super P carbon with Electrolyte F (see FIG. 3 for further details of electrolyte F). for comparison, a coin cell battery/capacitor hybrid was constructed using a lithium anode and a cathode consisting of 90 wt % LiNi_{0.5}Mn_{1.5}O₄ material 5 wt % Teflon® binder, 8.5 wt % Super P carbon and 8.5% ACF with Electrolyte F. The cells were discharged with 1-second pulses with 3.2%, 10% and 50% duty cycles, respectively. Each pulse string was terminated when the cell voltage dropped below 0.1 V. The average power density (W/kg) and average energy density (Wh/kg) are plotted in FIGS. 12 and 13, respectively. The results clearly show the enhancement in power and energy afforded by double-layer charging of the high-surface-area activated carbon fibers included in the electrochemical cell.

### Example 15

### Comparison of Li/LiNi_{0.5}Mn_{1.5}O₄ (with ACF) Cell Performance with Li/LiNi_{0.5}Mn_{1.5}O₄ (with MWCNT) Cell Performance

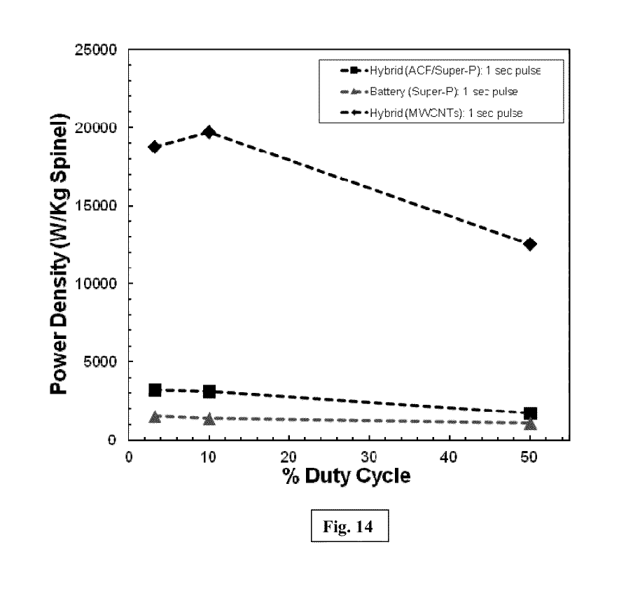

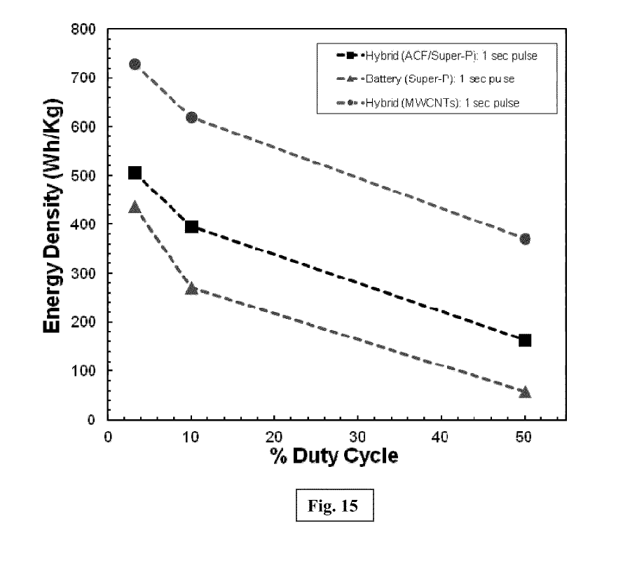

A coin cell was constructed using a lithium anode and a cathode consisting of 90 wt % LiNi_{0.5}Mn_{1.5}O₄ material 5 wt % Teflon® binder, 8.5 wt % Super P carbon with Electrolyte F (see FIG. 3 for further details of electrolyte F). Another coin cell was constructed using a lithium anode and a cathode consisting of 90 wt % LiNi_{0.5}Mn_{1.5}O₄ material 5 wt % Teflon® binder, 8.5 wt % Super P carbon and 8.5% MWCNT with Electrolyte F. The cells were discharged as in Example 14 with 1-second pulses with 3.2%, 10% and 50% duty cycles, respectively. Each pulse string was terminated when the cell pulse load voltage dropped below 0.1 V. The average power density (W/kg cathode) and average energy density (Wh/kg cathode) are plotted in FIGS. 14 and 15, respectively. The results demonstrate the enhancement in power and energy afforded by double-layer charging of the high-surface-area multi-walled carbon nanotubes included in the electrochemical cell.

### Example 16

### Demonstration of High-Voltage Charge/Discharge with a Li/LiNi_{0.5}Mn_{1.5}O₄ Cell According to the Teachings of the Present Invention

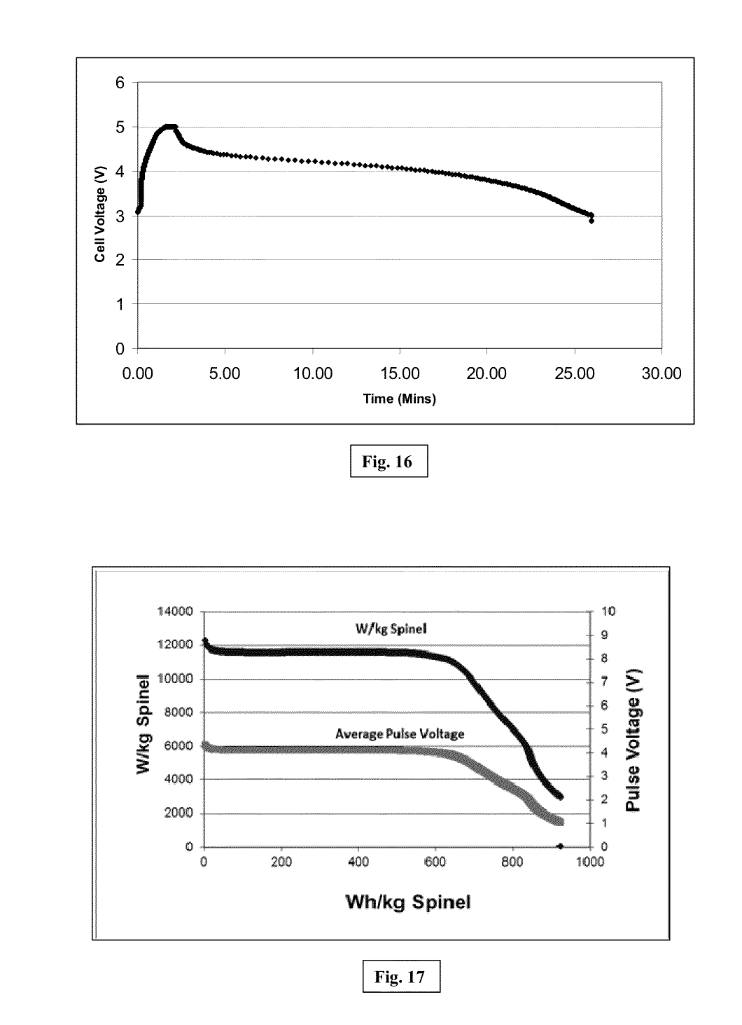

A coin cell battery was constructed using a carbon anode comprised of 90% SLP-50 graphite (Timcal, Inc.), 5% acetylene black (Chevron) and 5% polyvinylidine fluoride (Solvay) and a cathode consisting of 90 wt % LiNi_{0.5}Mn_{1.5}O₄ material 5 wt % Teflon® binder, 5 wt % Super P carbon with Electrolyte I (see FIG. 3 for further details of electrolyte I). The cell was charged at the 10 C rate (18 mA/g cathode) at constant current to 5.0 V and then allowed to charge at constant 5 V until the current dropped the C rate. The cell showed an open-circuit voltage of 4.8 V and was discharged a the 2C rate with a resulting average discharge voltage of 4.1 V over 30 minutes (see FIG. 16).

### Example 18

### Continuous Pulse String Discharge Comparison of a Li/LiNi_{0.5}Mn_{1.5}O₄ (with ACF) Cell with a Li/LiNi_{0.5}Mn_{1.5}O₄ (with MWCNT) Cell

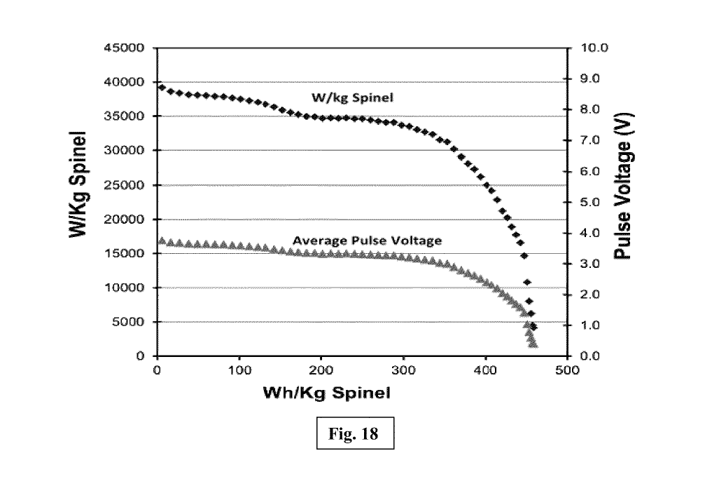

Two coin cells were constructed using a lithium anode and a cathode consisting of 80 wt % LiNi_{0.5}Mn_{1.5}O₄ material 5 wt % Teflon® binder, 2.5 wt % Super P carbon and 2.55% of either ACF or MWCNT high-surface-area carbon with Electrolyte F. One cell was continuously pulse-discharged at a rate of 2.2 Amps/g of LiNi_{0.5}Mn_{1.5}O₄ cathode material with a 3.2% duty cycle (1 second on load and 30 seconds on rest) until the cell voltage during pulse reached 0.1 V. The cell delivered over 600 Wh/kg LiNi_{0.5}Mn_{1.5}O₄ and showed an average voltage during pulses of 4.2 V. The average specific power was 11,700 W/kg LiNi_{0.5}Mn_{1.5}O₄ over the pulse string (FIG. 17). The second cell was pulse-discharged at the same duty cycle but at a higher rate of 10.4 Amps/g of LiNi_{0.5}Mn_{1.5}O₄ cathode material in order to achieve a higher specific power. The resulting pulse string (FIG. 18) showed an average voltage of 3.2 V, an average specific power of 35,000 W/kg and over 300 Wh/kg of LiNi_{0.5}Mn_{1.5}O₄ cathode material.

The cited examples are intended to give a sampling of the electrochemical performance of battery and hybrid battery/capacitor cells using combinations of the claimed materials which can withstand charge voltages of 4.8-5.0 V. It is understood to those conversant in the art that the optimal composition of cell electrolytes and electrodes can be adjusted and optimized for different applications depending on the ambient operating temperature, power and energy requirements. It is also known in the art that improvements in the performance of the cathode material can be made by selectively adding less the 1% of a fourth metal to the oxide or by removing a small amount of oxygen. Both of these approaches can improve lithium mobility in the materials and also improve the electronic conductivity. It is also understood that the herein claimed battery can be used as a primary, non-rechargeable cell, a rechargeable cell, or as a capacitor.

The embodiments of the present invention described above are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. An electrochemical cell comprising:
(a) an anode;
(b) a cathode, the cathode comprising a mixture of a first material, a second material, and a third material, the first material being a metal oxide, the second material being an elongated carbon structure, the third material being a conductive material;
(c) a separator; and
(d) an electrolyte;
(e) wherein the anode, the cathode, and the separator are operatively associated with the electrolyte.

2. The electrochemical cell as claimed in claim 1 wherein the metal oxide is electrically non-conductive.

3. The electrochemical cell as claimed in claim 2 wherein the metal oxide comprises a lithium-nickel-manganese oxide.

4. The electrochemical cell as claimed in claim 3 wherein the metal oxide is LiNi_{0.5}Mn_{1.5}O₄.

5. The electrochemical cell as claimed in claim 1 wherein the elongated carbon structure comprises at least one member of the group consisting of a carbon nanotube, a carbon fibril, and a carbon fiber.

6. The electrochemical cell as claimed in claim 1 wherein the elongated carbon structure comprises a carbon nanotube.

7. The electrochemical cell as claimed in claim 1 wherein the elongated carbon structure comprises a carbon fibril.

8. The electrochemical cell as claimed in claim 1 wherein the elongated carbon structure comprises a carbon fiber.

9. The electrochemical cell as claimed in claim 8 wherein the carbon fiber is an activated carbon fiber.

10. The electrochemical cell as claimed in claim 1 wherein the conductive material is conductive carbon.

11. The electrochemical cell as claimed in claim 1 wherein the cathode further comprises a fourth material, the fourth material being a binder.

12. The electrochemical cell as claimed in claim 1 wherein the binder is at least one member of the group consisting of polyvinylidine difluoride and polyvinylidine difluoridehexafluoropolypropylene block copolymer.

13. The electrochemical cell as claimed in claim 1 wherein the anode comprises lithium metal.

14. The electrochemical cell as claimed in claim 1 wherein the anode comprises a material selected from the group consisting of an intercalated carbon, a conductive carbon, and an elongated carbon structure.

15. The electrochemical cell as claimed in claim 1 wherein the electrolyte comprises a salt dissolved in a solvent system.

16. The electrochemical cell as claimed in claim 15 wherein the salt is a lithium salt.

17. The electrochemical cell as claimed in claim 16 wherein the lithium salt is at least one member of the group consisting of lithium hexafluoro phosphate, lithium tetrafluoroborate, lithium hexafluoroarensate, lithium perchlorate, lithium bis(oxalate)borate, lithium bis-(trifluoromethanesulfonyl)imide and lithium trifluoromethane sulfonate.

18. The electrochemical cell as claimed in claim 15 wherein the solvent system comprises a fluorinated solvent.

19. The electrochemical cell as claimed in claim 18 wherein the fluorinated solvent comprises at least one member of the group consisting of a fluorinated ester, a fluorinated alkyl dione, a fluorinated sulfolane, and a fluorinated hydrocarbon.

20. The electrochemical cell as claimed in claim 19 wherein the fluorinated solvent comprises a blend of at least two fluorinated hydrocarbons.

21. The electrochemical cell as claimed in claim 19 wherein the fluorinated solvent comprises a fluorinated ester solvent, the fluorinated ester solvent possessing a dipole moment in excess of 4.0.

22. The electrochemical cell as claimed in claim 18 wherein the fluorinated solvent comprises a fluorinated solvent of the formula
CH₃—(CH)ₙ—CO₂—(CH)ₘ—CF₃
wherein n and m are integers from 1 to 5 and are independent of one another.

23. The electrochemical cell as claimed in claim 18 wherein the fluorinated solvent comprises at least one member of the group consisting of 2,2,2-trifluoroethyl acetate, 2,2,2-trifluoroethyl butyrate, ethyltrifluoro acetate, methyl pentafluoropropionate, and 2,2,2-trifluoroethyl propionate.

24. The electrochemical cell as claimed in claim 18 wherein the fluorinated solvent comprises at least one fluorinated alkyl diketone of the formula
CF₃(CH₂)ₙ—(CO)—(CH₂)ₘ—(CO)—(CH₂)ₚCX₃
wherein n=0, 1, 2, 3, or 4, wherein m=1, 2, or 3, wherein p=0, 1, 2, 3, or 4, and wherein X═H or F.

25. The electrochemical cell as claimed in claim 18 wherein the fluorinated solvent comprises at least one member of the group consisting of 1,1,1-trifluoro-2,4-pentanedione and 1,1,1,5,5,5-hexafluoropentane-2,4-dione.

26. The electrochemical cell as claimed in claim 18 wherein the fluorinated solvent comprises at least one member of the group consisting of 3-monofluorosulfolant and 2,3-difluorosulfolane.

27. The electrochemical cell as claimed in claim 18 wherein the fluorinated solvent comprises at least one member of the group consisting of 1,1,1-trifluoro-2,4-pentanedione, 1,1,1,5,5,5-hexafluoropentane-2,4-dione, and 2,2,2-trifluoroethyl acetate and wherein the solvent system further comprises at least one member of the group consisting of 2,3-dihydrodecafluoropentane and the azeotropic mixture of CF₃CF₂CHCCl₂/CClF₂CF₂CHClF.

28. The electrochemical cell as claimed in claim 18 wherein the solvent system further comprises a carbonate solvent.

29. The electrochemical cell as claimed in claim 28 wherein the carbonate solvent is at least one member of the group consisting of propylene carbonate, butylene carbonate, ethylene carbonate, ethyl methyl carbonate, dimethyl carbonate, and partially fluorinated derivates thereof.

30. An electrochemical cell comprising:
(a) an anode;
(b) a cathode, the cathode comprising a mixture of a first material and a second material, the first material being a metal oxide, the second material being an elongated carbon structure, the elongated carbon structure being electrically conductive;
(c) a separator; and
(d) an electrolyte;
(e) wherein the anode, the cathode, and the separator are operatively associated with the electrolyte.

31. The electrochemical cell as claimed in claim 30 wherein the cathode further comprises a third material, the third material being a conductive carbon.

32. The electrochemical cell as claimed in claim 31 wherein the cathode further comprises a fourth material, the fourth material being a binder.

33. The electrochemical cell as claimed in claim 30 wherein the metal oxide is electrically non-conductive.

34. The electrochemical cell as claimed in claim 33 wherein the metal oxide comprises a lithium-nickel-manganese oxide.

35. The electrochemical cell as claimed in claim 34 wherein the metal oxide is LiNi_{0.5}Mn_{1.5}O₄.

36. The electrochemical cell as claimed in claim 30 wherein the elongated carbon structure comprises at least one member of the group consisting of a carbon nanotube, a carbon fibril, and a carbon fiber.

37. The electrochemical cell as claimed in claim 36 wherein the elongated carbon structure comprises a carbon nanotube.

38. The electrochemical cell as claimed in claim 36 wherein the elongated carbon structure comprises a carbon fibril.

39. The electrochemical cell as claimed in claim 36 wherein the elongated carbon structure comprises a carbon fiber.

40. The electrochemical cell as claimed in claim 39 wherein the carbon fiber is an activated carbon fiber.

41. The electrochemical cell as claimed in claim 30 wherein the anode comprises lithium metal.

42. The electrochemical cell as claimed in claim 30 wherein the anode comprises carbon.

43. The electrochemical cell as claimed in claim 30 wherein the electrolyte comprises a salt dissolved in a solvent system.

44. The electrochemical cell as claimed in claim 43 wherein the salt is a lithium salt.

45. The electrochemical cell as claimed in claim 43 wherein the solvent system comprises a fluorinated solvent.

46. The electrochemical cell as claimed in claim 45 wherein the fluorinated solvent comprises at least one member of the group consisting of 1,1,1-trifluoro-2,4-pentanedione, 1,1,1,5,5,5-hexafluoropentane-2,4-dione, and 2,2,2-trifluoroethyl acetate and wherein the solvent system further comprises at least one member of the group consisting of 2,3-dihydrodecafluoropentane and the azeotropic mixture of CF₃CF₂CHCCl₂/CClF₂CF₂CHClF.

47. A conductive coating, the conductive coating comprising a mixture of a first material, a second material, and a third material, the first material being a metal oxide, the second material being an elongated carbon structure, the third material being a conductive material.

48. The conductive coating as claimed in claim 47, wherein the conductive coating has a thickness of no more than about 3 millimeters.

49. The conductive coating as claimed in claim 47 further comprising a fourth material, the fourth material being a binder.

50. The conductive coating as claimed in claim 47 wherein the metal oxide is electrically non-conductive.

51. The conductive coating as claimed in claim 47 wherein the metal oxide comprises a lithium-nickel-manganese oxide.

52. The conductive coating as claimed in claim 51 wherein the metal oxide is LiNi_{0.5}Mn_{1.5}O₄.

53. The electrochemical cell as claimed in claim 47 wherein the elongated carbon structure comprises at least one member of the group consisting of a carbon nanotube, a carbon fibril, and a carbon fiber.

54. The electrochemical cell as claimed in claim 47 wherein the conductive material is a conductive carbon.

55. A cathode for use in an electrochemical cell, the cathode comprising a mixture of a first material, a second material, and a third material, the first material being a metal oxide, the second material being an elongated carbon structure, the third material being a conductive material.

56. The cathode as claimed in claim 55 further comprising a fourth material, the fourth material being a binder.

57. The cathode as claimed in claim 55 wherein the metal oxide is electrically non-conductive.

58. The cathode as claimed in claim 55 wherein the metal oxide comprises a lithium-nickel-manganese oxide.

59. The cathode as claimed in claim 55 wherein the metal oxide is LiNi_{0.5}Mn_{1.5}O₄.

60. The cathode as claimed in claim 55 wherein the elongated carbon structure comprises at least one member of the group consisting of a carbon nanotube, a carbon fibril, and a carbon fiber.

61. The cathode as claimed in claim 55 wherein the conductive material is a conductive carbon.

62. An anode for use in an electrochemical cell, the anode comprising a first material, the first material being at least one of an intercalated carbon, a conductive carbon, and an elongated carbon structure.

63. The anode as claimed in claim 62 wherein the elongated carbon structure comprises at least one of a carbon nanotube, a carbon fibril, and a carbon fiber.
